(19) United States
(12) Patent Application Publication
(10) Pub. No.: US 2012/0233876 A1
(43) Pub. Date: Sep. 20, 2012

(54) Dryer Heat Recovery system

(76) Inventors: Kevin Weldon, Greensburg, PA (US); Thomas Weldon, Pittsburgh, PA (US)

(21) Appl. No.: 13/416,181

(22) Filed: Mar. 9, 2012

Related U.S. Application Data
(60) Provisional application No. 61/465,195, filed on Mar. 14, 2011.

(51) Int. Cl. F26B 19/00; F26B 3/02

(52) U.S. Cl. 34/513; 34/86

(57) ABSTRACT

An improvement in a laundry dryer system using recovered waste heat from the hot air exhaust of the dryer to transfer that heat to the incoming ambient fresh air. A home laundry dryer in which both the fresh air entering a laundry drum and the air exhausted from the drum pass through thermal recovery ducting. The dryer heat recovery system has concentric ducting including a high temperature passage through which the exhaust air flows and a separate low temperature passage through which the entering air flows. Heat from the exhausted air is transferred from the high temperature passage to the entering air in the low temperature passage. This heat transfer lowers the energy required to raise the entering air to a desired drying temperature. The dryer ducting is designed to have an outer diameter equivalent to standard size ducting on home dryers.

### CROSS REFERENCES TO RELATED APPLICATION

This application claims the benefit of the filing date of U.S. provisional application No. 61/465,195 filed Mar. 14, 2011, for “Dryer Heat Recovery System”, and is herein incorporated by reference.

### FIELD OF THE INVENTION

The present invention relates generally to commercial and domestic clothes dryers. Clothes dryers are generally box shaped cabinets having a single swinging door for permitting a user to place and remove clothes from the dryer. Most home dryers are about approximately waist high on an adult of average height.

Generally, a clothes dryer is separately installed from a washing machine thereby to automatically dry wet clothes that have completed a washing operation. According to a drying method, clothes dryers can be divided into a condensation type and an exhaust type.

The present invention is an improvement of an exhaust type clothes dryer. The exhaust type clothes dryer employs a blower which draws in external air, heats the drawn in air by a heater that is introduced into a rotating drum having clothing, and discharges air that has passed through the drum outwardly, thereby drying clothes inside the drum.

This invention relates to home laundry dryers and more particularly to dryers having a thermal recovery unit to decrease energy (eg fuel or electricity) consumption.

### BACKGROUND OF THE INVENTION

In home laundry dryers, laundry in a tumble drum is subjected to a flow of heated, dry air. When the air leaves the drum, it is still relatively hot compared to fresh air, and contains moisture absorbed from the laundry and also lint.

In a home laundry drying system, when the air passes through the lint filter and leaves the drum, it is hot compared to ambient air. Discarding the exhaust of the dryer into the environment is not economical or a responsible approach in an effort to conserve our natural resources.

The operating efficiency of any conventional laundry dryer is substantially increased, with a proportionate decrease in energy cost by preheating the air entering the heating unit of the dryer.

Considerable energy savings may be effected in those instances in which the lint and moisture laden, hot exhaust gaseous media are utilized for preheating ambient air which is then introduced into the chamber. The energy required for heating the ambient fresh air entering the drum could be reduced, if heat from the drum exhaust could be used in the drying process, rather than simply discarded in the exhaust of the dryer.

U.S. Pat. No. 3,859,735 details a dryer preheater for a clothes dryer that has a heat exchanger for heating inlet ambient air with exhaust air. The preheater comprises a large housing having a myriad of baffles that extend across the chamber defining the intake and discharge chambers and the heat exchange chamber there between. Elongated heat exchange tubes provide the interface between the fluid mediums with an output passage to feed the preheated air to the dryer intermediate the ends of the housing. Such a preheater is large and bulky and expensive to manufacture. In addition substantial friction losses occur on account of the added flow restriction on the passage of the inlet air into the dryer.

U.S. Pat. No. 3,969,070 discloses a typical heat saver for a commercial clothes dryer, wherein a portion of the lint and moisture laden exhaust gases are diverted back toward the combustion chamber in such a manner as to pre-heat the ambient air which is introduced to the combustion chamber, whereby to be intermixed with and then recirculated through the dryer housing for effecting a savings in energy.

The problem with U.S. Pat. No. 3,969,070 and other similar designs (U.S. Pat. No. 4,106,214) of lint and moisture laden products of combustion that are recirculated through the housing, the rotating drum and the articles within the rotating drum which are being dried. Carrying moisture back to the drum is an ineffective manner to dry clothes.

These immediately above discussed prior art heat exchangers are fairly large and bulky as well. There size makes them impractical and they are not readily installed in the space typically set aside for washer and dryers in a home.

In most instances there is limited space for the addition of a heat exchanger in and around an installed home dryer. Particularly today when many dryers are not necessarily installed in the basement but are frequently installed on the first and second floor of a residence. The heat exchanger should fit in a home dryer system but still have the heat transfer capacity to provide useful energy recovery.

As discussed above there is a need in the industry for domestic and commercial dryers that waste less energy and are more energy efficient. There is also a need for a dryer system that is relatively compact and inexpensive to manufacture.

### SUMMARY

It is an object of the present invention to provide an improved preheater for a dryer that transfers heat from the exhaust to the incoming ambient fresh air.

It is an object of the present invention to provide an improved preheater for a dryer for clothes or the like wherein the dryer structure is maintained compact for ease of installation and manufacturing economy, while increasing the heat transfer efficiency to a maximum.

The present invention employs a more compact heat exchanger that requires a minimum of additional space or none, and is a highly effective heat exchanger as well. This heat exchanger is used to transfer heat between the exhaust air and ambient inlet air stream of a dryer. The present invention integrates a heat exchanger system into a home dryer of standard size and shape. The resulting dryer machine has features which permit it to be operated and maintained in the confined installation space commonly encountered in the home. The result is a practical dryer system that saves energy and does not take up excessive space in the home.

To achieve these and other advantages, there is provided a clothes dryer comprising: a cabinet; a drum rotatably installed within the cabinet; and an exhaust duct for discharging air having passed through the drum, wherein the exhaust duct envelopes and surrounds an inlet tube supplying ambient air. The ambient air is preheated by the exhaust heat as it is drawn into the dryer.

The foregoing and other objects, features, aspects and advantages of the present invention will become more apparent from the following detailed description.

### BRIEF DESCRIPTION OF THE DRAWINGS

For use in better understanding the exemplary systems and methods for the Dryer Exhaust Heat Recovery system described hereinafter, reference may be had to preferred embodiments shown in the following drawings in which:

FIG. 1 is a sectional view showing a clothes dryer according to the present invention.

FIG. 2 is a sectional view showing a clothes dryer according to a second embodiment of the present invention.

FIG. 3A is a partial rear view taken along section 3-3 (however with the external ducting detached) of the section of the dryer for receiving the coaxial exhaust and vent ducting employed in the FIG. 2 embodiment.

FIG. 3B is a partial rear view taken along section 3-3 (however with the external ducting detached) of the section of the dryer of an alternative opening for receiving the coaxial exhaust and vent ducting employed in the FIG. 2 embodiment.

### DETAILED DESCRIPTION

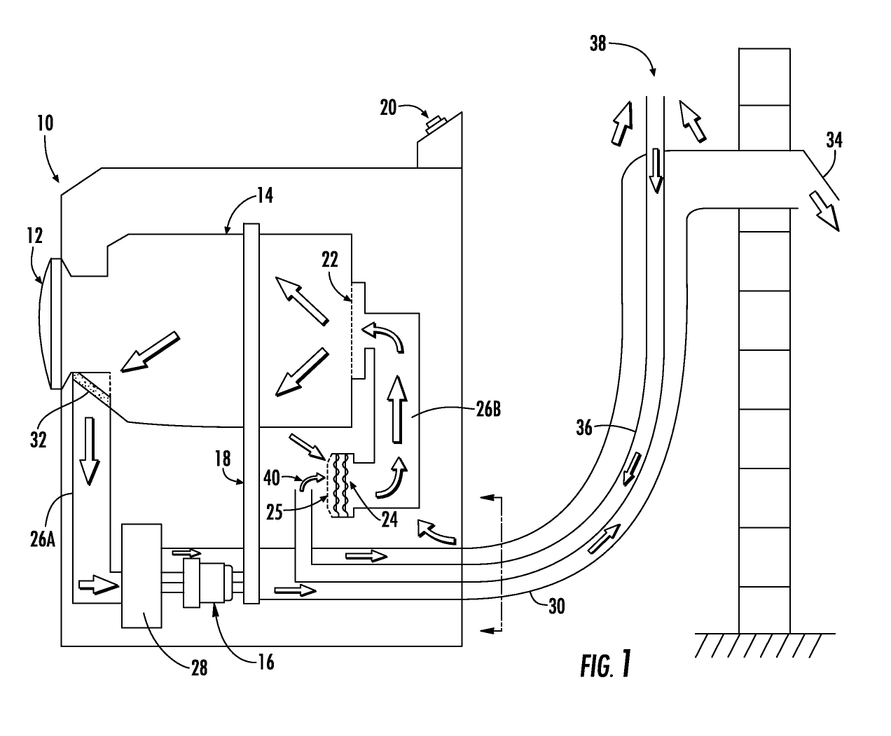

The following describes various systems and methods for recovering waste heat from the hot air vented from the dryer. By way of example, FIG. 1 illustrates an exemplary system.

As illustrated in FIG. 1, with reference to the drawings, numeral 10 generally designates a clothes and laundry dryer. A control board 20 is provided for selecting the various operation cycles of the dryer 10. The front panel includes an access opening with a door 12 pivotally mounted for movement between open and closed positions relative to the access opening.

A tumble drum 14 is provided within the cabinet. The drum 14 is rotatably mounted within the dryer cabinet. A motor 16 and drive belt 18 is provided for rotating the drum 14. The driving motor 16 is installed at an internal lower portion of the cabinet. The driving motor 16 and the drum 14 are connected by a pulley and belt 18, so that the driving force of the driving motor 16 is transmitted to the drum 14.

The drum 14 also includes a stationary rear wall mounted so as to sealingly engage the rearward end of the drum.

In the preferred embodiment, an air inlet opening 22 is provided in the rear wall. The air inlet 22 comprises a plurality of openings in the rear wall of the drum 14 such that the heated drying air can be introduced into the drum 24.

A heating unit 24 is mounted on the rearward side of the rear wall of the drum 14. The heating unit 24 is open to permit air flow through the heating unit 24 for heating by the coils. In operation, as a column of air passes through the heating unit 24, the coils heat the air flowing into the drum.

A suction duct (26A, 26B) is connected to a suction port of the air blower 28 in order to draw air into the drum 14, and a heating unit 24 for heating the air sucked into the drum 14 is installed at an inlet portion of the suction duct section 26B. The suction duct section 26B and heating unit 24 have an inlet 25 comprising of a plurality of openings for receiving air. The dry heated air exits suction duct passage 26B into the drum 14 for drying wet laundry located therein. The air enters the suction duct 26A adjacent a lint filter 32. The air at this point is laden with lint and moisture. Some of the lint is separated from the air flow by the filter 32. The moist air laden with remaining portion of lint is sucked into the blower 28. The outlet of the air blower 28 is connected to an exhaust duct 30. The exhaust duct 30 transports the moist lint laden air outside the dryer cabinet through a building wall exiting into the outdoors via a discharge outlet 34.

The exhaust duct 30 envelopes an inner coaxial preheater tube 36. The preheater tube 36 includes an inlet 38 at one end and an outlet 40 at the preheater tubes opposite end. The preheater tube outlet 40 is located adjacent to the inlet 25 of the suction duct. Cooler ambient air is sucked into the opening 38 of the preheater tube and through outlet 40 via the suction force created by the air blower 28. Upon existing outlet 40 this cooler air is next sucked into the opening 25. This cool air is then heated by heater unit 24 and continues through of the suction duct portion (26B) and into rotating drum 14.

It is contemplated that concentric flexible exhaust-vent duct pipe of the present invention may incorporate a flexible duct as disclosed in U.S. Pat. No. 6,234,163 (Garrod). The outer duct and inner duct disclosed therein are fixed into coaxial position by a spacer. For additional information regarding flexible concentric ducts, U.S. Pat. No. 6,234,163 is incorporated herein by reference in its entirety. Further it is envisioned that other alternative spacers could be configured and modified as desired to restrict the flow of air in the annular passage. The flow of air in the outer annular flow passage may be designed to flow at a high flow rate or relatively low flow rate. Accordingly the heat transfer rate of the preheater can be configured as desired by varying the rate of flow restriction caused by the spacer positioned between the inner and outer coaxial ducts.

The present invention efficiently employs lint/moisture laden, hot gaseous exhaust media in duct 30 to envelope and preheat the ambient air flowing through inner tube 36. The preheated air is additionally heated in the heating unit 24 prior to entering the dryer drum 14. Accordingly at least a portion of the waste heat in the exhaust duct is recovered by the concentrically arranged exhaust duct 30 and air intake tube 36.

In an effort to further increase the heat transfer efficiency of exhaust air from the duct to the inner tube 36 it is envisioned that the outer surface of the duct 30 may be insulated so as to better maintain the high temperature of the exhaust air. A higher temperature exhaust air improves the rate and amount of heat transferred into the central ambient inlet air flow. The insulation it is contemplated may be installed both on the exhaust ducting outside the dryer and/or inside the dryer.

In addition, a restriction detecting system (not shown) for sensing the existence of blockages in the exhaust duct 30 may be used with the present invention. A pressure sensor is inserted within the exhaust duct adjacent the inner surface of the dryer cabinet rear wall. For additional information regarding a restriction detecting system, U.S. Pat. No. 6,785,981 is incorporated herein by reference in its entirety.

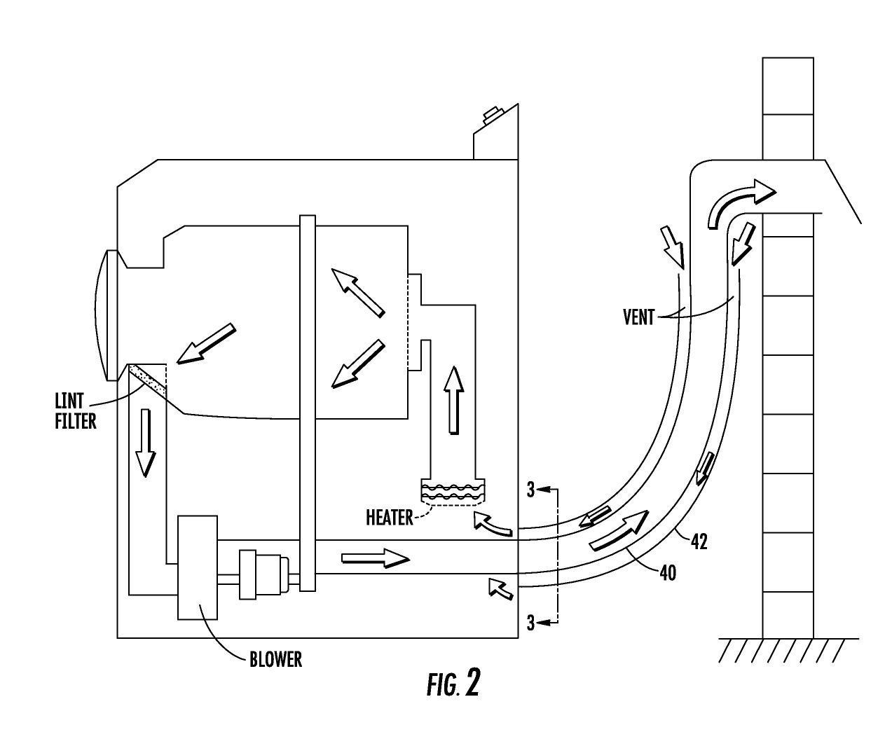

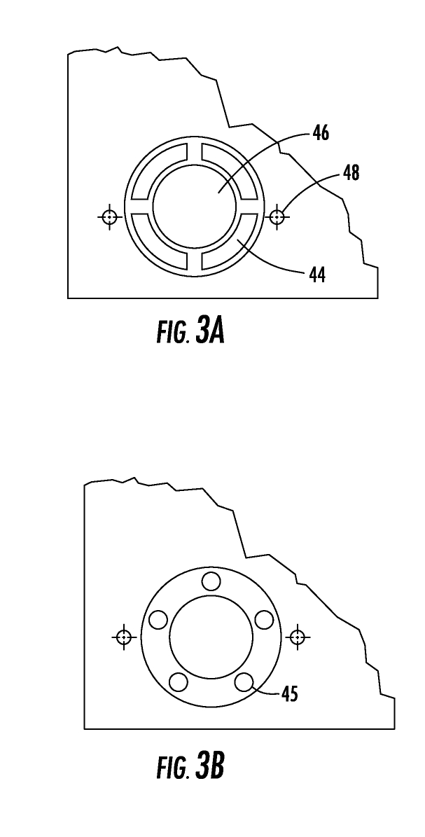

FIG. 2 is a second embodiment of the invention wherein the inner concentric tube is connected to the outlet of the air blower and the annular passage formed between the inner tube 41 and outer duct 42 conveys the ambient fresh air into the dryer. In this instance the rear wall of the dryer would be modified to include a plurality of concentric arc-shaped openings positioned around the central exhaust opening 46, as shown at 44 in FIG. 3A. The external ducting inner tube 41 would be connected to the inner central exhaust outlet 46 from the dryer and the outer concentric external ducting 42 would be attached to the rear wall of the dryer for communication with the concentric annular openings 44. The coaxial ducting would be connected to the openings on the rear wall of the dryer by a bolted (or sheet metal screws) collar and clamp or other well-known fastening means in the art. In this alternative embodiment the ambient fresh air vent would simply communicate with the interior of the dryer cabinet at the rear wall and be sucked into the heater and suction duct by the vacuum created by the air blower.

At the ambient air inlet end of this embodiment illustrated in FIG. 2 the outer coaxial passage 42 extends to a position adjacent to where the exhaust duct passes through the wall and exits the building, an inlet vent opening is located at this point for receiving ambient room air inside the building. It is contemplated that a grate for instance may be fastened to the vent opening to prevent large objects or other potential obstructions from entering the inlet of the ambient air vent.

In addition another embodiment of the invention is illustrated in FIG. 3B wherein the vent openings are not arcuate shape 44 but circular openings 45.

It is contemplated that an existing dryer might be readily modified into the structural configuration of the FIG. 3B embodiment by drilling openings 45 and drilling bolt holes 48 in the rear wall of an existing dryer. Once the dryer is drilled coaxial ducting similar to that disclosed in the FIG. 2 embodiment can be connected to the modified dryer. Also, any existing fresh air vent holes on an already manufactured dryer may be covered and plugged, for instance see the illustrated vent holes 11 in the rear wall of the dryer disclosed in U.S. Pat. No. 6,698,107. Some or all of these existing holes may be covered by any suitable means well known in the industry. U.S. Pat. No. 6,698,107 is incorporated in its entirety. Such an adaption would be fairly inexpensive and accomplished in quick fashion by an ordinary skilled artisan.

In addition a further preferred embodiment of the present invention is contemplated wherein the air blower is located in the rearward section 26B of the suction duct so as to expel air into the rotating drum through the openings 22 into the drum 14. U.S. Pat. No. 7,069,669 to Park et al. discloses a dryer wherein a scroll air blower is located in ducting on the rear portion of the dryer for drawing ambient air inside the cabinet and propelling it through a heater and into the rotating drum. U.S. Pat. No. 7,069,669 is incorporated herein by reference in its entirety. It is contemplated that in this preferred embodiment that the pressurized hot air exits the drum via a preheating concentric exhaust duct similar to those either illustrated in FIG. 1 or FIG. 2.

It should be appreciated that in the embodiments illustrated in FIG. 1 (without insulation on external duct) that more heat will be dissipated into the indoor room in comparison to the FIG. 2 embodiment. In FIG. 1 the exhaust duct 30 section located from between the dryer and exterior building wall dissipates exhaust heat directly through its duct wall into the laundry room. In the FIG. 2 embodiment the exhaust duct 41 on the other hand is surrounded by the outer coaxial preheater ducting 42 that vents air into the dryer. This surrounding concentric preheater ducting 41 functions quite well to insulate this exhaust duct section from dissipating the exhaust heat into the laundry room. In summary, for dryers using equally rated heaters and blowers, the embodiment as illustrated in FIG. 1 would heat the laundry room more than the embodiment illustrated in FIG. 2.

In another preferred embodiment it is contemplated that a third concentric duct is employed to surround the exhaust duct 30 in FIG. 1. This third outer duct would be configured similar to the preheater vent duct 42 as shown in FIG. 2. Whereby the exhaust duct is positioned between an inner central core preheater vent duct tube and a second surrounding outer preheater vent duct. Valve means are incorporated with the inner core preheater duct and outer surrounding preheater duct so that these two preheater vent ducts can be used alternatively. For instance if it is desired to better heat the laundry room, the inner core preheater duct would be open and the outer preheater duct closed by the valving means. Alternatively if is desired to reduce heating of the laundry room the outer preheater duct would be open and the inner core preheater duct closed.

There is a substantial effort made by industry to improve the efficiency of devices in which waste heat is utilized to do useful work. The present dryer system invention utilizes exhaust heat to preheat the incoming ambient air and bolster the efficiency and economy of operation of the dryer. Conservation of heat energy on major appliances will assist in the battle against depletion and abuse of global natural resources.

The present invention provides for a practical and realistic approach to recapturing waste heat without incurring significant manufacturing costs in constructing a heat exchanger the present invention is compact and does not require a substantial amount of space to accommodate a bulky heat exchanger.

The invention claimed is:

1. A dryer heat recovery apparatus for a dryer comprising:
an outer preheater duct, said outer preheater duct enveloping an exhaust duct on said dryer.

2. A dryer heat recovery apparatus according to claim 1, wherein said outer preheater duct is substantially an elongated cylindrical tube.

3. A dryer heat recovery apparatus according to claim 1, wherein said outer preheater duct has a substantially circular cross section.

4. A dryer heat recovery apparatus according to claim 1, wherein said outer preheater duct is connected to the dryer by fastening means.

5. A dryer heat recovery apparatus according to claim 1, wherein said outer preheater duct has a first upstream inlet and a second downstream outlet, said second downstream outlet is connected to the dryer by fastening means.

6. A dryer heat recovery apparatus according to claim 5, wherein said outer preheater duct is a substantially elongated cylindrical tube, said tube having a first end and a second end, said first end including said first upstream inlet and said second end including said second downstream outlet.

7. A clothes dryer heat recovery system comprising:
a cabinet, a blower in said cabinet, a heater for heating ambient air drawn into said blower, a suction passage for communicating said heated air into a rotating drum,
an exhaust duct and a preheater duct wherein said exhaust duct and said preheater duct are substantially coaxial.

8. A dryer heat recovery system according to claim 7, wherein said exhaust duct and said preheater duct are both substantially elongated tubes.

9. A dryer heat recovery system according to claim 7, wherein said exhaust duct has an exhaust inlet end and exhaust outlet end and said preheater duct has a preheater inlet end and preheater outlet end,
said exhaust duct inlet end is closer to said preheater duct outlet end than said preheater duct inlet end.

10. A dryer heat recovery system according to claim 9, wherein said exhaust duct and preheater duct are concentric.

11. A dryer heat recovery apparatus according to claim 9, wherein said preheater duct is connected to the dryer by fastening means.

12. A dryer heat recovery apparatus according to claim 11, wherein said preheater duct is surrounded by insulation.

13. An method for modifying a conventional domestic dryer to recover lost heat energy, said dryer comprising a cabinet, said cabinet having existing ventilation inlet openings formed therein, a blower in said cabinet, a heater for heating ambient air drawn into said blower, a suction passage for communicating said heated air into a rotating drum, a substantially tubular exhaust duct for communicating said heated air from said cabinet to a discharge outlet for discharging the heated air outdoors,
the method steps comprising of:
providing a preheater duct wherein said preheater duct is a substantially elongated tube having a first upstream inlet and a second downstream outlet,
disconnecting said tubular exhaust duct from a central exhaust outlet on said cabinet,
forming holes in said cabinet circumscribing said central exhaust duct outlet,
enveloping said exhaust duct with said preheater duct,
reconnecting said exhaust duct to said central exhaust duct outlet,
connecting said preheater duct to the dryer cabinet by fastening means, and
covering or plugging prior existing ventilation inlet openings.

14. The method as claimed in claim 13, wherein the step of forming holes comprises drilling holes.

15. The method as claimed in claim 14, wherein said fastening means comprises screws.
